(19) United States
(12) Patent Application Publication
(10) Pub. No.: US 2024/0429776 A1
(43) Pub. Date: Dec. 26, 2024

(54) MOTOR WITH IMPROVED ACOUSTICS

(71) Applicant: MOVING MAGNET TECHNOLOGIES, Besancon (FR)

(72) Inventor: Valentin Préault, Osselle (FR)

(21) Appl. No.: 18/704,397

(22) PCT Filed: Oct. 24, 2022
(86) PCT No.: PCT/FR2022/052010

§ 371 Date: Apr. 24, 2024

(30) Foreign Application Priority Data
Oct. 27, 2021 (FR) FR2111438

(51) Int. Cl. H02K 5/24

(52) U.S. Cl. CPC H02K 5/24

(57) ABSTRACT

A slotted, electric radial flux machine includes a stator that has a stator axis and consists of two stator parts connected by a plurality of teeth, some or all of which are surrounded by coils. The stator parts have first and second patterns, respectively, in a plane perpendicular to the stator axis. Each of the teeth surrounded by coils is an extension of one of the patterns and has a front end engaging with a receiving region of the other of the patterns in order to form a point of contact that is constrained within the plane.

### CROSS-REFERENCE TO RELATED APPLICATIONS

This application is a national phase entry under 35 U.S.C. § 371 of International Patent Application PCT/FR2022/052010, filed Oct. 24, 2022, designating the United States of America and published as International Patent Publication WO 2023/073312 A1 on May 4, 2023, which claims the benefit under Article 8 of the Patent Cooperation Treaty of French Patent Application Serial No. FR2111438, filed Oct. 27, 2021.

### TECHNICAL FIELD

The present disclosure relates to a wound stator for a rotary electric machine and to a rotary electric machine including such a wound stator.

### BACKGROUND

Radial electric machines comprising a rotor and a stator are known in the prior art. The flux circulates radially between the stator and the rotor, and the rotor can be internal or external. The stator comprises a stator body typically formed by laminations provided with teeth for mounting coils. The stator body comprises slots open toward the interior or the exterior, each delimited by two consecutive teeth. These teeth preferably have parallel edges and extend substantially radially from a tubular yoke located on the side opposite the rotor.

For reasons of mechanical strength, the slots can be connected by a second ring gear thin enough not to degrade the magnetic performance of the stator. This ring gear can cause tooth tips to appear to increase the magnetic performance of the motor. This ring gear located on the air gap side also makes it easier to overmold the motor and to reduce the magnetic disturbances of the magnets on the conductors.

To simplify the winding of the stator, the body of the stator is generally made in two parts. A ring gear comprising teeth is wound, then the magnetic structure is closed by the second ring gear. It is often chosen to minimize the residual air gap at the junction between the two ring gears. Sometimes, a rigid embedding is chosen between the two ring gears, but it is difficult to ensure that the junctions align correctly throughout the production and, in certain configurations, these electric machines produce sound and vibration disturbances.

Utility model DE202016104686U1 describes a motor designed to improve starting reliability. It comprises a stator with a core formed by an outer yoke and a plurality of teeth extending inward from the outer yoke. Paragraph of this document specifies that each tooth 33 is securely welded to the outer yoke 31 or connected by various other means of mechanical connection (e.g., by a dovetail joint) can be firmly connected. In an alternative embodiment, the teeth 33, the yoke 31 and the inner ring area are all formed separately and the teeth 33 are secured to the yoke 31 and the inner ring area after the stator winding 39 has been made.

Patent application DE10242404 describes a stator formed by laminations that has an annular configuration and comprises pole teeth interconnected by annular segments, and projecting outwards. These pole teeth are embedded in the ribs of an outer ring gear. The aim is to better control the torque ripple and the power of the electric machine.

Patent application US20090195108 describes a stator structure intended to inexpensively improve thermal performance and efficiency. This stator comprises windings and a ferromagnetic core, the ferromagnetic core comprising a first core element in contact with a second core element via teeth closing the slots intended for the insertion of the windings of the coils.

Patent application EP3154171 describes another example of a stator aimed at improving the efficiency and continuous performance of an electric machine, and at improving cooling. This stator comprises a casing that, taken alone or together with the stator body, completely encloses a cooling volume through which the coolant can flow except for at least one coolant inlet and at least one coolant outlet; the cooling volume encloses at least the coils, the stator casing being paramagnetic and/or ferromagnetic in its entirety or in several field guiding regions.

Patent application US20110309711 proposes a solution to facilitate the manufacture of a wound stator consisting in:
joining a plurality of laminations together to produce a first stack of laminations defining teeth, slots between adjacent teeth and a yoke section connecting the teeth together,
mounting coil elements on the teeth such that portions of the coil elements are arranged in at least some of the slots between adjacent teeth, and
fitting a second stack of laminations to an inside diameter of the first stack of laminations and securing the second stack in place to function as tooth tips.

British patent GB842157 proposes a stator structure, the aim of which is that of reducing the risk of damage to the insulation of the wires. The magnetic core has four parts of complementary shapes arranged so that by placing the sections in the same plane, they can be rigidly locked together by inserting a locking element.

Patent U.S. Pat. No. 2,251,674 describes an electric machine aimed at improving the electrical characteristics and simplifying the mechanical construction by a few parts that can be produced at low cost and assembled easily and inexpensively. stator is composed of substantially identical cooperatively associated segments that collectively form a complete outer magnetic ring, a complete inner magnetic ring surrounding the rotor, and substantially radial poles connecting the outer and inner rings. The poles consist in each case of a main pole section II integrally connected to and forming part of the outer magnetic ring and of a lesser pole section arranged on one side of the main pole section and that is integrally connected to and forms part of the inner magnetic ring.

None of the prior art documents discuss the problem of noise reduction, but instead generally discuss mechanical construction and electrical, thermal and mechanical control. The solutions envisaged lead to constructions generating noise caused by the variations of the magnetic interactions and the mechanical resonances of the mechanical parts.

These noises result from the rigid mechanical connection, by a single piece including the yoke and the teeth, or by teeth bearing against the yoke by congruent recesses, without play or the possibility of relative motion, between each of the teeth and the stator yoke, which transmit vibratory frequencies each time a magnet passes in front of a tooth, creating periodic variations in the “magnet-lamination” attraction forces, as well as frequencies due to static and dynamic unbalance, exciting the different motor excitation modes.

### BRIEF SUMMARY

The present disclosure proposes a solution to this technical problem that involves deliberately imposing a mechanical interference greater than the manufacturing tolerances, between the two stator elements to be assembled. This mechanical interference has the advantage of being able to be absorbed by elastic bending of a tooth or by a combination of elastic motions. Under such stress, the two stator elements can be assembled easily and are then held together by the force exerted by the deformed tooth or teeth. This makes it possible to transmit the torque and to tension each of the teeth with the ring gear.

More particularly, the disclosure relates to a slotted, electric radial flux machine.

The machine comprises a stator, which has a stator axis and consists of two stator parts connected by a plurality of teeth, some or all of which are surrounded by coils, the stator parts having a first and a second pattern, respectively, in a plane perpendicular to the stator axis. Each of the teeth surrounded by coils is an extension of one of the patterns and has a front end engaging with a receiving region of the other of the patterns in order to form a point of contact that is constrained within the plane.

In particular, the straight lines normal to the contact surface passing through the points of contact are not concurrent at a single point coinciding with the stator axis.

An alternative formulation of the disclosure defines a slotted, electric radial flux machine comprising a stator, which has a stator axis and includes two stator parts connected by a plurality of teeth, some or all of which are surrounded by coils. The stator parts have a first and a second pattern, respectively, in a plane perpendicular to the stator axis, each of the teeth surrounded by coils being an extension of one of said the patterns and having a front end engaging with a receiving region of the other of the patterns. The first and second patterns have at least one overlapping area at the point of engagement between the end and the receiving region, the overlapping area being able to be absorbed by an elastic deformation, greater than the manufacturing tolerances, of at least one or the other of the stator parts linked to the movement of the end.

Non-limitingly, the stator has at least three teeth surrounded by coils and making a constrained point of contact.

Furthermore, the extent of the area of the constrained point of contact is less than 5% of the periphery of the tooth end.

In a particular case, all the teeth consist of extensions of only one of the two stator parts.

Alternatively, the teeth consist partly of extensions of one of the stator parts and partly of extensions of the other of the stator parts.

According to a particular embodiment, the front end of at least one of the teeth is convex and the corresponding receiving region is concave, with a greater radius of curvature.

Equivalently, the front end of at least one of the teeth can be concave, and the corresponding receiving region can be convex, with a lower radius of curvature.

Another option may be for the front end of at least one of the teeth to be convex and the corresponding receiving region to be flat.

Without additional imitation, the front end of at least one of the teeth and its corresponding receiving region can both be convex.

In an advantageous embodiment for industrialization, the two stator parts include stacked laminations that can be cut from the same stack of laminations, one of the first or second patterns fitting into the other of the first or second patterns while having play compatible with an industrial cutting method.

In a particular embodiment, the rotor is external to the stator.

The alternative is that the rotor is internal to the stator.

Thus, non-limitingly, the stator may have an alternation of wide teeth and narrow teeth, only three teeth being intended to receive coils and being located in an angular sector a of angular extent less than 180°.

In a particular embodiment, the first stator part is overmolded with a plastic body forming a coil body on each of the wound teeth, the coil body axially extending the end of the teeth by a flared groove.

In particular, the flared grooves of the plastic body have sufficient rigidity to withstand the elastic deformation stresses of the first or second stator part exerted during assembly by axial insertion of the first and second stator parts.

### BRIEF DESCRIPTION OF THE DRAWINGS

The present disclosure will be better understood on reading the description of a non-limiting embodiments of the disclosure that follows, with reference to the appended drawings, where:

FIG. 1 shows a perspective view of a stator according to a first embodiment of the disclosure;

FIGS. 2 and 3 show a view of the stator patterns, according to the embodiment of FIG. 1, respectively before and after assembly of the stator parts;

FIGS. 4 and 5 show views of the stator patterns, according to an alternative embodiment, respectively before and after assembly of the stator parts;

FIGS. 6, 7, 8, and 9 show a detailed view of various examples of points of contact according to the present disclosure;

FIG. 10 shows a perspective view of a stator according to an alternative embodiment;

FIG. 11 shows a view of the stator patterns according to the embodiment of FIG. 10 after assembly of the stator parts;

FIG. 12 shows a detailed view of the constrained point of contact according to the embodiment of FIGS. 10 and 11;

FIG. 13 shows a view of the stator patterns according to an alternative embodiment after assembly of the stator parts;

FIG. 14 shows a perspective view of the second stator part provided with coils, according to the embodiment of FIG. 13;

FIGS. 15 and 16 show views of the stator patterns, according to an alternative embodiment, respectively according to the cutting orientation and according to the assembly orientation;

FIGS. 17 and 18 show views of the stator patterns, according to an alternative embodiment, respectively according to the cutting orientation and according to the assembly orientation;

FIG. 19 shows a perspective view of a stator according to the embodiment of FIGS. 17 and 18;

FIG. 20 shows a view of the stator patterns according to an asymmetric alternative embodiment after assembly of the stator parts;

FIG. 21 shows a view of the stator patterns according to a second asymmetric alternative embodiment after assembly of the stator parts;

FIGS. 22 and 23 show views of the stator patterns, according to a third asymmetric alternative embodiment, respectively before and after assembly of the stator parts;

FIG. 24 shows a view of the stator patterns according to an alternative embodiment with non-radial teeth after assembly of the stator parts;

FIG. 25 shows a view of the stator patterns, according to a variant embodiment with teeth with flared ends, after assembly of the stator parts; and

FIG. 26 shows a perspective view of the first stator part, according to an alternative embodiment having a plastic overmolding.

### DETAILED DESCRIPTION

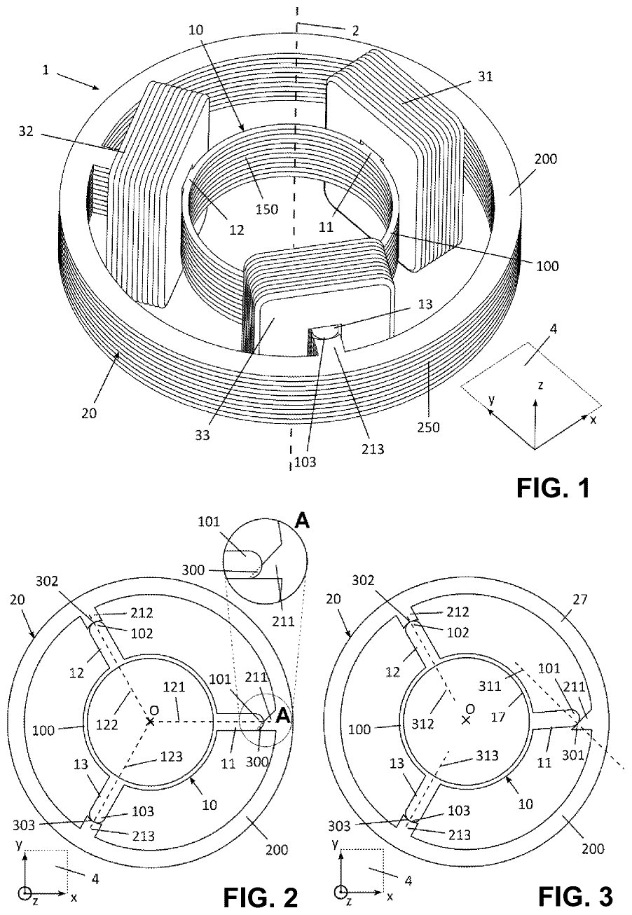

The general principle of the present disclosure can be assessed with reference to FIGS. 1, 2, 3, 4 and 5. The disclosure relates to single-phase or polyphase low-noise electric motors where the stator assembly (1) consists of two stator parts (10, 20) connected by teeth (11 to 13) extending in radial directions, the teeth being surrounded in a known manner by a coil (31 to 33). It is not necessary for all the teeth to be surrounded by a coil, and it is sufficient for one tooth per phase to be surrounded by a coil. FIG. 1 shows a perspective view of the stator assembly (1).

The disclosure relates to so-called “slotted motor” electric machines consisting of a ferromagnetic cylinder having teeth separated by slots allowing the windings to be accommodated therein. This cylinder generally consists of a stack of laminated sheet plates in order to limit eddy currents. It differs from smooth rotor motors without slots, known as “slotless motors.”

The two stator parts (10, 20) are formed by stacks of ferromagnetic laminations (150, 250), typically in soft iron, cut respectively according to a first pattern and a second pattern (100, 200). These patterns (100, 200) are defined in a transverse plane (4), orthogonal to the stator axis (2), i.e., the plane (x, y), which is also called the main plane of the laminations. It is, of course, not necessary for all the laminations of the stacks of one or the other stator part to come from a single cutting pattern, certain laminations of the stacks possibly coming from a pattern constituting a sub-part of the first or second patterns (100, 200). Similarly, it is possible that no lamination comes from the first or second patterns (100, 200), but only from sub-parts of these patterns, the assembly of the laminations nevertheless giving rise to obtaining the first and second patterns (100, 200) when the stacks are viewed in the direction of the axis of rotation of the motor.

Each of the teeth (11 to 13) constitutes a radial extension of one of the first or second patterns (100, 200), the tooth end (103) of which engages with a receiving region (213) of the other of the first or second patterns (100, 200) to form a constrained point of contact.

“Point of contact” means that the parts in contact between one end of the tooth (103) of one of the stator parts (10, 20) and the receiving region (213) of the other of the stator parts (10, 20), seen in the main transverse plane (4) of the laminations, are as narrow as possible and, of course, within the limits of industrial feasibility. As used herein, the term “point of contact” is not limited to the strict mathematical definition of “contact without size or dimension,” but means that the contact surface is a little greater than the machining and manufacturing tolerances, and typically less than 5% of the periphery of the tooth end or that of the corresponding receiving region, when the stator parts (10, 20) are physically produced and assembled. As a result, the two stator parts (10, 20) cannot be engaged one in the other without effort but require forcing an elastic deformation to allow the engagement of one stator part in the other, the two then remaining assembled by the wedging resulting from this elastic deformation.

When the motor is assembled, the two stator parts (10, 20) are held firmly by these constrained points of contact. To separate them, a significant axial force is necessary, greater than five times the cumulative weight of the stator parts (10, 20), to extract one from the other.

Once extracted, the two stator parts (10, 20) cannot be reassembled by simply sliding one into the other without significant effort (at least five times greater than the combined weight of two stator parts (10, 20)), by imposing an elastic deformation on one part relative to the other.

Because these patterns have a single point of contact, the contact between the two stator parts (10, 20) forms a pivot connection with a degree of angular freedom in one direction or the other with respect to the rest position, each tooth (11 to 16) rolling without slipping on the corresponding receiving region (211 to 216).

In summary, each of the teeth (11 to 16), the surface of the opposite tooth with complementary stator part has:
a single line of contact forming a non-slip rolling pivot connection with angular freedom in one direction or the other with respect to the rest position,
and the rest of the opposite surface, on either side of this line of contact, is non-congruent.

Due to this single point of contact at the patterns (100, 200), the two stator parts (10, 20) come into contact at a single line formed by the succession of line segments formed at the stack of laminations.

Thus, the first and second patterns (100, 200) have, in the configuration corresponding to the assembled position, at least one overlapping area (300) at the point of engagement between the tooth end (101 to 106) and the receiving region (211 to 216), the overlapping area (300) being absorbed by elastic deformation, greater than the manufacturing tolerances, of at least one or the other of the stator parts (10, 20) linked to the movement of the tooth end (101 to 106).

Generally, the straight lines parallel to the median axes of each tooth and passing through the points of contact (301 to 306), are not concurrent at a single point coinciding with the stator axis (2).

FIGS. 2 and 3 illustrate views in axial incidence (z) of the stator assembly (1), respectively before and after assembly of the two stator parts (10, 20); the coils (31, 32, 33), visible in FIG. 1, are not shown to simplify reading. “Axial incidence view (z)” means the image obtained by projection of the stator assembly in a plane (4) orthogonal to the axis (z), this image showing only the contours of the projected objects and, therefore, being different from a sectional view. The first and second cutting patterns (100, 200) have an annular geometry and the first pattern (100), carrying all of the teeth (11, 12, 13), is located inside the second pattern (200). In this particular example, the first pattern (100) has 3 teeth (11 to 13), each having a longitudinal plane of symmetry (121 to 123), and the tooth ends (101 to 103) of which are intended to engage with receiving regions (211 to 213) of the second pattern (200) so as to form three points of contact (301 to 303), i.e., one per tooth. In this embodiment, two teeth (12, 13) are angularly aligned with their respective receiving region (212, 213) and show the point of contact between circular end teeth (102, 103) and their receiving region (212, 213) having an elliptical shape, or a circular shape with a larger radius. The third tooth (11), for its part, has a circular end (101), angularly offset from its planar receiving region (211), so that there is a partial overlap (300) of the two patterns (100, 200), shown most visibly by inset A in FIG. 2. As shown in FIG. 3, the partial overlap (300) between the two patterns (100, 200) can be absorbed by involving a movement of the tooth end (101) so as to have a point of contact (301).

This translates an important element of the present disclosure, namely the impossibility of simultaneously aligning all the tooth ends (101, 102, 103) with their receiving region (211, 212, 213). In other words, there will always be a partial overlap (300) between the two patterns (100, 200), and more precisely between a tooth end (101, 102, 103) and its receiving region (211, 212, 213), this overlap being able to be absorbed by a movement of the tooth end (101, 102, 103). This results in a need to elastically deform at least one of the first or second stator parts (10, 20) in order to be able to assemble the stator. Once assembled, this deformation makes it possible to generate a force at all of the points of contact (301, 302, 303), even if only one of the teeth (101, 102, 103) had a partial overlap (300) of the patterns. The previously mentioned constrained points of contact are thus obtained.

It should be noted that the thickness of the overlapping area (300) is strictly greater than the manufacturing tolerances during the design, i.e., for example, an overlap greater than 20 μm for motors ranging from 10 mm to 50 mm in outer diameter. The movement of the tooth ends can vary from 10 μm to 0.5 mm on the basis of the geometry of the receiving regions. For larger diameter motors (50 mm to 150 mm), the length of the teeth can be longer, and the movement of the tooth ends can be greater (up to 1 mm) without deteriorating the magnetic performance of the motor. The movement is nevertheless dimensioned to remain within the elastic deformation range of the stator parts (10, 20). Insofar as the overlapping area produced in the design phase is very close to the manufacturing tolerances, it is possible for the parts produced to have a smaller overlapping area than the tolerances because of production dispersions. In fact, for example, for a motor with an outer diameter of 20 mm, if during the design phase the planned overlapping area is 25 μm while the manufacturing tolerances on each of the stator parts are 10 μm, in the most unfavorable case, the overlapping area will be assigned 10 μm for each of the stator parts, i.e., 20 μm in total, leaving only 5 μm of overlap between the parts actually produced. The overlapping area would, therefore, be less than the tolerances, but the elastic deformation is still necessary to assemble the two stator parts. The disclosure, therefore, relates to the design of overlapping areas greater than the manufacturing tolerances so as to ensure that the elastic deformation is still necessary once the stator parts have been produced and impacted by the manufacturing tolerances. Finally, it should be noted that the manufacturing tolerances are not limited here because they intrinsically depend on the manufacturing method used, which is not limiting with respect to the disclosure. A person skilled in the art will nevertheless know how to adapt any design according to the method in question so as to obtain the elastic deformation of the stator parts.

The shapes of the tooth ends (101, 102, 103) and of the receiving regions (211, 212, 213) are designed to have only a single point of contact (301, 302, 303), respectively, and whatever the actual deviations from the ideal pattern, these deviations remain within manufacturing tolerances. Thus, depending on manufacturing variations, the location of the point of contact between the end of a tooth and its receiving region may vary depending on the actual geometry, but the uniqueness of this point of contact is ensured.

This single point of contact becomes an axial line contact when the two stator parts (10, 20) are assembled. This type of contact advantageously leaves a degree of freedom in rotation in the plane (4), centered on the point of contact. As soon as it is perfectly mastered, such a degree of freedom is beneficial for reducing the vibratory stresses transmitted between the two stator parts (10, 20), which has a beneficial impact on the level of noise emitted by the machine during operation. The forces, related to the elastic deformation of the two stator parts (10, 20), associated with the friction between each tooth end (101, 102, 103) and its associated receiving region (211, 212, 213), result in obtaining rolling and non-sliding contacts, which overcome the problems related to contacts by uncontrolled friction. Indeed, a dry friction is accompanied by a sudden relaxation of the stresses when the elements in contact leave their adhesion situation; this sudden relaxation results in a very broadband spectral excitation, which is a source of a very perceptible acoustic disturbance. An alternative solution to the rolling contact is the addition of a lubricant between the areas in contact to create a sliding contact; this constitutes an additional production cost and poor control of the aging of the actuator, the lubricant being able to deteriorate with time or simply leave the useful area. The creation of a rolling contact, therefore, has an advantage in terms of cost and reliability compared to known solutions for reducing the vibratory stresses transmitted between the two stator parts (10, 20). In the context where this rolling contact is respected, it is envisaged that the extent of the point of contact may evolve during the rolling of a tooth end on the corresponding receiving region, this evolution possibly occurring depending on the geometries used.

FIGS. 2 and 3 show a preferred configuration where, to absorb the partial overlap (300) of the two patterns (100, 200), it is necessary to generate a movement involving at least one tangential motion of the tooth. “A movement involving at least one tangential motion of the tooth” is understood to mean a potentially combined motion, but which requires at least one tangential movement of the tooth end with respect to the stator axis (2) of rotation of the motor. It is nevertheless not excluded that this motion also requires a translation in the plane (4) of the pattern.

Of course, the number of tooth ends (101, 102, 103) and receiving regions (111, 112, 113) that have a partial pattern overlap (300) is not limited to one, like in the example of FIG. 2, but can assume a value between 1 and N, N being the number of teeth in the stator. It should be noted that a value N means that it is not possible for any position of teeth, and of receiving regions, to absorb the partial overlap (300) without involving a translational motion of a tooth end (101, 102, 103).

In the example shown in FIG. 2, the partial overlapping area (300) between the two patterns has been deliberately exaggerated. In reality, the deformations necessary for the assembly of the first and second stator parts (10, 20) remain of low amplitude. Above all, it is necessary to ensure that these deformations are greater than the manufacturing tolerances in order to guarantee effective point of contact (301, 302, 303) between each of the teeth (11, 12, 13) and its receiving region (211, 212, 213), as shown in FIG. 3. We will retain as a rule that the stresses necessary for the assembly of the first and second stator parts (10, 20) remain within the range of the elastic deformations of their component materials, while being greater than the manufacturing tolerances.

A characteristic, visible in FIG. 3, making it possible to ensure the constrained point of contact (301, 302, 303) by taking into account manufacturing dispersions is that the lines normal (311, 312, 313) to the contact surfaces at each point of contact (301, 302, 303) are not all concurrent at a point located on the stator axis (2). The term “stator axis” means the axis usually collinear with the axis of rotation of the motor. In the present case, the stator axis (2) constitutes the center of the various annular yokes (17, 27) constituting the peripheries of the stator parts (10, 20), and is located at the intersection of the longitudinal planes of symmetry (121, 122, 123) of the teeth before assembly of the stator parts, as shown in FIG. 2. It is nevertheless possible to imagine asymmetrical shapes of the first and/or second stator parts (10, 20) for which the teeth (11, 12, 13) do not have a perfectly radial extension. In the example of FIG. 2, the place of engagement to be avoided is, therefore, located at the intersection (O) of the longitudinal planes of symmetry (121, 122, 123) of the teeth rather than exclusively on the stator axis (2).

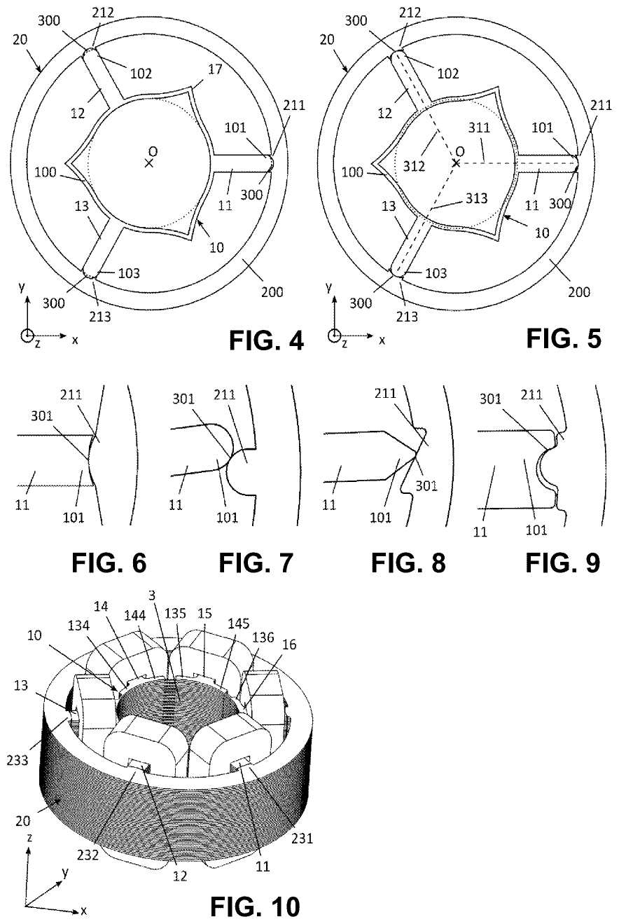

An alternative embodiment of these constrained points of contact is shown in FIGS. 4 and 5. FIG. 4 shows the patterns (100, 200), before assembly of the two stator parts (10, 20), and having a partial overlap (300) between each tooth end (101, 102, 103) and its receiving region (211, 212, 213), respectively. As shown in FIG. 5, this partial overlap (300) can be absorbed by radial translation of the teeth, permitted by the mechanical elasticity of the annular yoke (17) inside the first stator part (10), in order to give rise to the constrained points of contact (301, 302, 303). This embodiment is a limiting case for which the lines normal (311, 312, 313) to the contact surfaces at each point of contact (301, 302, 303) are concurrent at a point located on the stator axis (2).

The benefits of the constrained point of contact between each tooth and its receiving region are multiple. First of all, the construction in two stator parts (10, 20) makes it possible to facilitate industrialization by automating the assembly of the coils (31, 32, 33) on the teeth (11, 12, 13). Indeed, the multiple coils (31, 32, 33) can, for example, be made in parallel on a plastic body and then inserted on the teeth (11, 12, 13) by the free end, before assembly of the two stator parts (10, 20). This makes it possible to improve the production speed of the coils (31, 32, 33), but also provides better winding regularity and, therefore, quality.

The constrained contact also makes it possible to ensure that there is no residual play, or air gap, between a tooth (11, 12, 13) and its receiving region (211, 212, 213). Such an air gap is prohibitive to achieve the acoustic performance required for drastic specifications. Indeed, when the stacks of stator laminations are subjected to the magnetic excitations of the rotor and the winding, the magnetic flux circulates between the two stacks of laminations between the tooth ends (101, 102, 103) and their receiving regions (211, 212, 213), respectively. The presence of play in these locations results in a discontinuity of the magnetic permeability and a pulsating attraction force appears locally between the two stator parts (10, 20). This pulsating attraction force can induce deformations large enough to cause periodic collisions between the two stator parts (10, 20). These collisions are sources of vibration and noise, drastically degrading the acoustic performance of the machine.

In this context, the production of a single constrained point of contact (300) for each wound tooth (11, 12, 13) is not insignificant. In fact, cutting complementary patterns (100, 200) having multiple points of contact is not viable from the perspective of industrial production, because the manufacturing tolerances do not make it possible to guarantee effective simultaneous contact at the various desired points. Residual air gaps may then appear that are liable to cause harmful collisions between the two stacks of stator laminations.

Using patterns (100, 200) according to the present disclosure is a judicious alternative. The manufacturing dispersions do not allow precise location of the points of contact (301, 302, 303), but the chosen cutting shapes guarantee their uniqueness. Effective contact is then ensured by the need to elastically deform at least one of the two stator parts (10, 20) to assemble it to the other one.

Finally, it should be noted that the number of constrained points of contact is not defined by the number of phases that the motor comprises, nor by its number of teeth. It may be chosen to leave an air gap greater than the manufacturing tolerances between one tooth and the other stator part. This leads to an air gap that reduces the magnetic performance of the motor but can simplify production and assembly. It is imperative to have a constrained point of contact at all the junctions where minimizing the magnetic air gap between the two stator parts is desired. It will be noted that the minimum number of points of contact enabling the two stator parts to be correctly assembled is two.

A result reflecting all of these characteristics can be summarized as follows:
each of the wound teeth (11, 12, 13) constitutes a radial extension of one of the first or second patterns (100, 200) and the tooth end (101, 102, 103) of which engages with a receiving region (211, 212, 213) of the other of the first or second pattern (200, 100) to form a constrained point of contact (301, 302, 303).

### Example of Making Points of Contact

FIGS. 6, 7, 8 and 9 illustrate, for a tooth (11), different shapes of complementary cutouts making it possible to ensure the uniqueness of the point of contact (301) according to the present disclosure, without this list being limiting. For example, FIGS. 6 and 9 show a tooth end (101), partially or totally of concave geometry and engaging with a convex shape of its complementary receiving region (211). FIG. 7 illustrates an alternative for which both the tooth end (101) and its receiving region (211) have convex shapes. Finally, FIG. 8 illustrates a tooth end (101) in the form of a point engaging with a planar receiving region (211).

### Detailed Description of a First Embodiment

FIGS. 10, 11 and 12 illustrate an embodiment of a stator of a machine with six wound teeth (11 to 16), respectively with a perspective view and a projection view along the axial direction of the stator.

In this embodiment, the first stator part (10) is formed by pole shoes (131 to 136), extending over approximately 50° each extended at their center by a tooth (11 to 16), and alternating with isthmuses (141 to 146) of small width, extending over approximately 10°, to define a tubular channel (3) in which the rotor is accommodated. The end of each tooth (11 to 16) having a concave shape engages with the second stator part (20) by making a constrained point of contact (301 to 306).

Thus, the second stator part (20) has six radial projections (231 to 236) positioned opposite the six teeth (11 to 16), respectively, each of these projections (231 to 236) being crossed in the middle by a spoke (241 to 246) and forming a receiving region (211 to 216), in the form of a convex support surface, capable of receiving the end of a tooth (11 to 16). The radius of curvature of the convex surface is slightly less than the radius of curvature of the concave surface to ensure the constrained point of contact (301 to 306) according to the disclosure.

In this embodiment, and as shown more specifically in FIG. 12 for a tooth (11), the constrained point of contact (301) is obtained owing to a slight tangential offset (321) of the cutting pattern of the convex part of the projection (231), with respect to the spoke (241) passing through the middle of the projection (231). The offset implies that the place of possible contact is no longer located on the spoke (241) but is on the same side as the tangential offset (321) of the cutting pattern of the convex part of the projection (231) with respect to the spoke (241). The offset, therefore, requires a tangential movement (341) of the end of the associated tooth (11) to assemble the two stator parts (10, 20) and giving rise to the constraint sought to ensure the uniqueness of the contact. The direction of the offset (321) can vary for each projection (231 to 236). It should be noted that the alternation of the offset direction (321) for each projection (231 to 236), while remaining of the same standard, makes it possible to balance the forces at the constrained points of contact (301 to 306) once the first and second stator parts (10, 20) are assembled.

It should be noted that even if the radii of curvature of the tooth end (101) and the receiving region (211), shown in FIG. 12, are slightly different, it is nevertheless not ruled out to use identical radii of curvature. Indeed, using two different radii of curvature ensures that a single point of contact is obtained; nevertheless, two identical forms of curvature can still be in contact over a limited extent, as taught in the disclosure, from the moment they are in contact in a non-concentric way. The engagement of identical and concentric curvatures, giving rise to contact over the entirety of one or the other of the two curvatures is, therefore, excluded from the disclosure.

### Detailed Description of a Second Embodiment

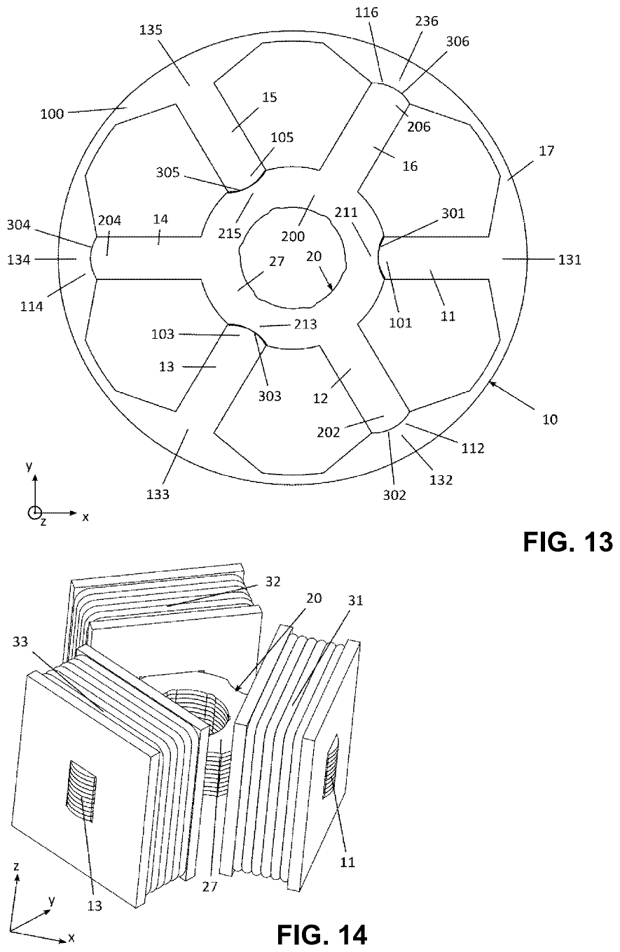

FIGS. 13 and 14 illustrate a second embodiment according to the present disclosure, respectively, with a view in projection along the axial direction of the two stator parts (10, 20) assembled but devoid of coils (only to improve clarity) and a perspective view of the second stator part (20) carrying the coils (31, 33, 35). This embodiment differs from the previous embodiment in that the first stator part (10) is located outside the second stator part (20) to form an outer rotor geometry, the rotor (not shown) being of diameter greater than the annular yoke (17). This embodiment also differs in that the first stator part (10) alternately has pole shoes (131, 133, 135) extended radially toward the center of the stator by teeth (11, 13, 15), the tooth end (101, 103, 105) of which is convex in shape, and alternatively concave receiving regions (112, 114, 116) capable of receiving the ends (202, 204, 206) of another set of teeth (12, 14, 16) radially outwardly extending the second stator part (20), located within the first stator structure (10). The second stator part (20) also has convex receiving regions (211, 213, 215) capable of receiving the concave ends (101, 103, 105) of the teeth of the first stator part (10).

This embodiment also differs in that it comprises only three coils (31, 33, 35), visible in FIG. 14, each being carried by a tooth (11, 13, 15) of the second stator structure (20). As shown in FIG. 14, this configuration with three coils (31, 33, 35) makes it possible to increase the copper section of the coils while retaining the magnetic and mechanical properties of a 6-tooth structure.

This embodiment also differs from the previous embodiment in that the receiving regions (111 to 116) are not located at the end of radial projections, but directly in the inner shape of annular yoke (27) of the second stator structure (20) or in the pole shoes (132, 134, 136) devoid of teeth of the first stator structure (10).

### Detailed Description of a Third Embodiment

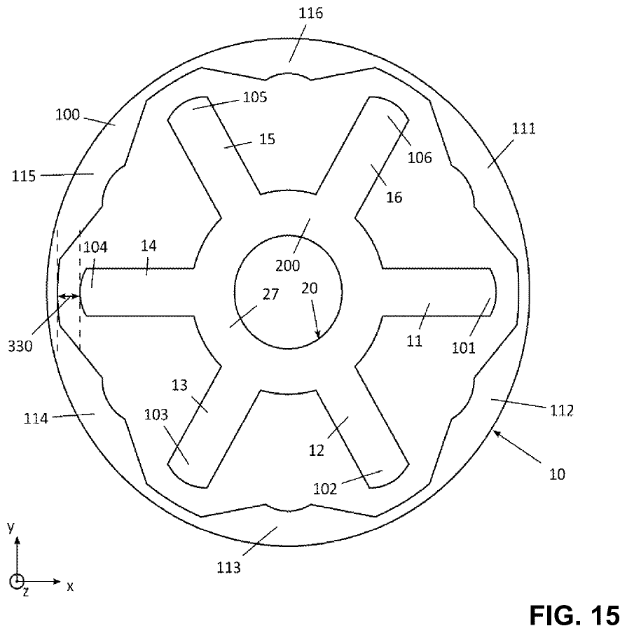

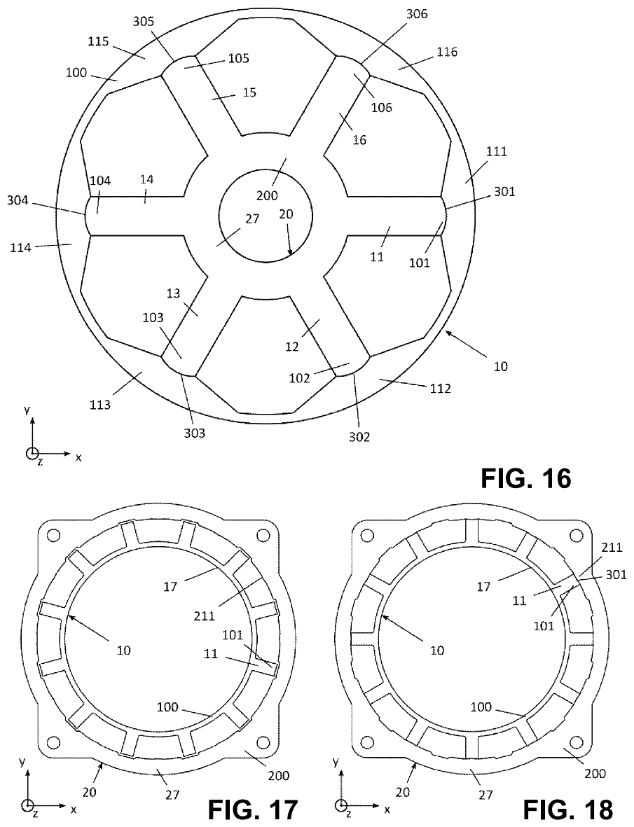

FIGS. 15 and 16 illustrate a third embodiment according to the present disclosure highlighting the possibilities of optimizing the cutting of the stator laminations to be compatible with mass production. This embodiment differs from the previous embodiment in that all the teeth (11 to 16) are carried by the second stator structure (20), the first stator structure (10) having all the receiving regions (111 to 116) of the ends (201 to 206) of the teeth.

FIG. 15 illustrates the patterns (100, 200) oriented for cutting. This orientation advantageously makes it possible to always have a minimum distance (330) between the two patterns (100, 200) so as to be able to cut them in the same lamination while ensuring effective contact when the patterns (100, 200) are oriented in their assembly direction as shown in FIG. 16. Indeed, a cut, whether by shearing of material or by ablation, is always accompanied by a loss of material or local deformations giving rise to shrinkage of material, so that cuts in their assembly orientation in one and the same lamination, the obtained laminations could not be assembled without play.

Of course, this orientation technique does not limit this embodiment and can be applied to all complementary patterns (100, 200) having an orientation at a minimum distance (330) compatible with the cutting techniques used in mass production.

### Detailed Description of a Fourth Embodiment

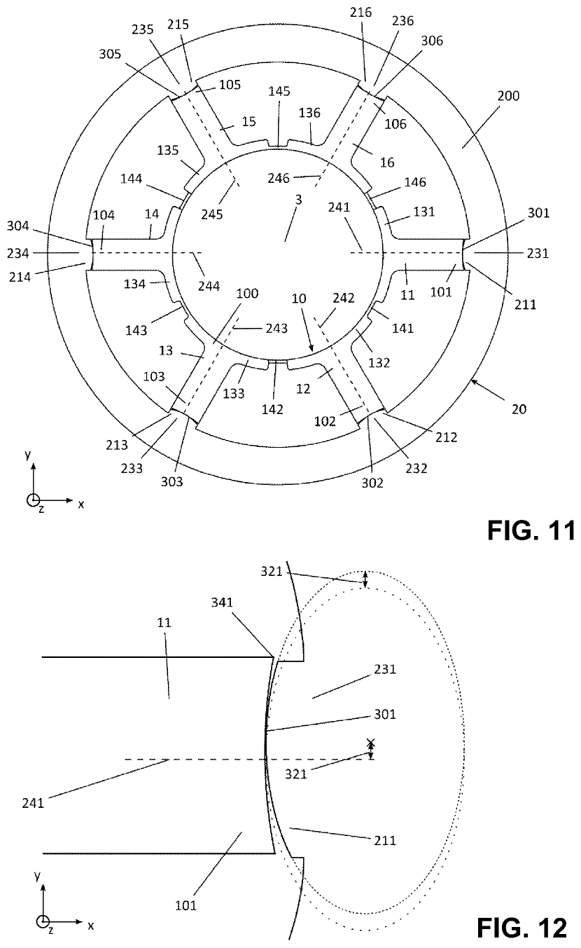

FIGS. 17, 18 and 19 illustrate an alternative embodiment of an internal rotor with twelve teeth (11). Compared with the embodiment shown in FIGS. 10 and 11, this embodiment is particularly interesting when the teeth (11) are quite short and the radial space allocated to the coils (31 to 36, 61 to 66) must be maximized. Indeed, in the embodiment shown in FIGS. 10 and 11, the receiving regions are located at the end of the radial projections (231 to 236), which means that the teeth (11 to 16) do not extend over the entire space between the annular yokes (17, 27) of the first and second patterns (100, 200). Since the coils (31) are inserted on the teeth before the axial driving of one of the stator parts (10, 20) into the other, their radial extension must not interfere with projections. Thus, eliminating the projections makes it possible to maximize the radial extension of the coils (31). So as to make this embodiment compatible with the industrial cutting techniques for laminations, the principle of differentiated orientation presented in FIGS. 15 and 16 is also used here. The patterns are, therefore, cut as shown in FIG. 17, the annular yoke (27) of the second pattern having clearances vis-à-vis the tooth ends (101) and located in quadrature with the receiving regions (211). Once cut, the patterns (100, 200) are oriented in the direction shown in FIG. 18 so as to match the tooth ends (101) with their respective receiving regions (211) to obtain the constrained points of contact (301).

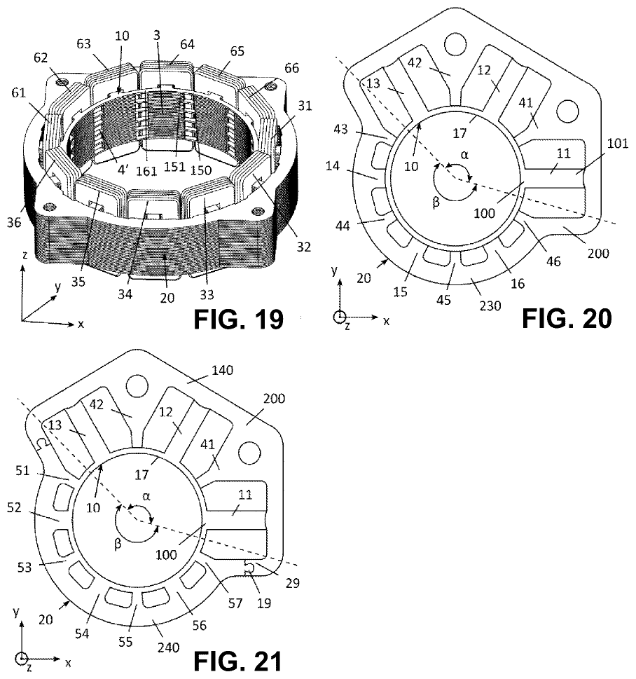

FIG. 19 is a perspective view of this stator enabling its axial extension to be assessed. The tubular channel (3) of the first stack of stator laminations has rectangular openings (4′). The openings are obtained by using two different cutting profiles to produce the stack of laminations of the first stator part (10), one corresponding to that shown in FIG. 17 and the other simply consisting of separate teeth. During assembly of the stack of laminations, one lamination (150) comes from the first pattern (100) for six laminations (151) from the second pattern (not shown). A similar embodiment is used in FIG. 10 with a lower ratio, every other lamination coming from one or the other of the patterns. This multiplicity of cutting patterns is an additional industrial complexity, but a reasonable additional cost with respect to the significant benefits obtained on the performance of the machine. Indeed, the pole sections (161) located opposite the rotor and joining the teeth (11) constitute a short-circuit of the magnetic flux preventing good coupling between the fluxes generated by the stator and the rotor. FIG. 19, therefore, proposes to reduce the impact of the pole sections (161) by using mostly laminations from the second cutting profile and that are devoid thereof. The proportion of laminations from the first pattern (100), that is to say, having pole sections (161), is, therefore, a compromise between an acceptable rate of short-circuited flux and the mechanical performance based on these pole sections (161), such as the good behavior of the structure and its stiffening in the radial plane. FIG. 10, which shows isthmuses (144) to limit the magnetic short-circuit, constitutes an interesting alternative. However, it must incorporate more laminations having these isthmuses (144) to ensure sufficient mechanical rigidity.

### Detailed Description of a Fifth Embodiment

FIG. 20 illustrates an alternative embodiment according to the disclosure having an asymmetric stator structure. In this embodiment, the stator has alternating wide teeth (11, 12, 13, 14, 15, 16) and narrow teeth (41, 42, 43, 44, 45, 46) whereof only 3 teeth (11, 12, 13) are intended to receive coils and are located in an angular sector a of angular extent less than 180°. These 3 wound teeth (11, 12, 13) are the only ones belonging to the first stator part (10) and extend radially from the annular yoke (17). The second stator part (20) consists of a peripheral yoke (240) extended radially in the direction of the annular yoke (17) by the other teeth (14, 15, 16, 41, 42, 43, 44, 45, 46). It should be noted that since all the teeth situated in the second sector B, complementary to the first sector a, do not carry coils, their radial extension can be reduced to the minimum necessary for the correct circulation of the magnetic flux without leaks. Thus, the peripheral yoke has a reduced radial extension, over the majority of the angular sector β, which makes it possible to limit the size of the motor. This embodiment is particularly advantageous when the motor is associated with a motion reducer.

### Detailed Description of a Sixth Embodiment

FIG. 21 illustrates a variant embodiment similar to the embodiment shown in FIG. 20. Compared to the previous embodiment, this differs in that the peripheral yoke (230) of FIG. 20 is split into two parts (140, 240) and all of the teeth (51, 52, 53, 54, 55, 56, 57) located in the second angular sector β as well as the part of the peripheral yoke (140) supporting them this time are an integral part of the first pattern (100). Indeed, since all these teeth are devoid of coils, they can be shortened to have a greater stiffness and overcome the need to mechanically decouple them from the peripheral yoke (140). The first and second stator parts (10, 20) have complementary shapes (19, 29), here dovetails, located in each of the two parts of the peripheral yoke (140, 240), making it possible to secure them by axial driving in. This embodiment is a means of saving material when cutting laminations, the previous embodiment not being compatible with a different angular orientation of the patterns (100, 200) between the cutting and the assembly of the stacks of laminations, as described in FIGS. 15 and 16.

### Description of a Seventh Embodiment

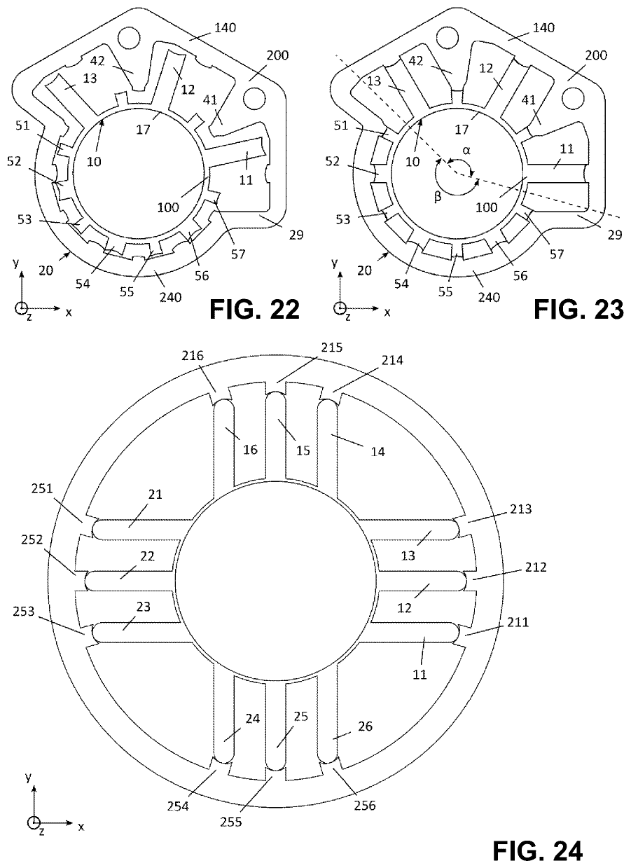

FIGS. 22 and 23 illustrate a variant embodiment similar to the embodiment shown in FIG. 20, FIG. 22 illustrating the two patterns (100, 200) in the cutting orientation of the laminations and FIG. 23 in the assembly orientation. This embodiment differs from the embodiment shown in FIG. 20 in that all the teeth (11, 12, 13, 14, 15, 16, 41, 42, 43, 44, 45, 46) radially extend the annular yoke (17) of the first stator part (10).

### Description of an Eighth Embodiment

FIG. 24 illustrates a variant embodiment for which certain teeth (11 to 16, 21 to 26) are not radial. In this embodiment, each radial tooth (12, 15, 22, 25) is located between two teeth (11, 13; 14, 16; 21, 23; 24, 26) that are parallel to it. This embodiment is advantageous for simplifying the insertion of the coils on the teeth for motors comprising a large number of them; the coils supported by parallel consecutive teeth can be inserted in a single operation by an automatic assembly line, which is a significant time saving representing substantial savings. As this figure shows, the non-radial teeth (11, 13, 14, 16, 21, 23, 24, 26) can engage with receiving regions (211, 213, 214, 215, 251, 253, 254, 256) to form a constrained point of contact. It should be noted that the principle would be identical if the radial teeth (12, 15, 22, 25) were removed; the disclosure is, therefore, not conditional on the presence of radial teeth.

### Description of a Ninth Embodiment

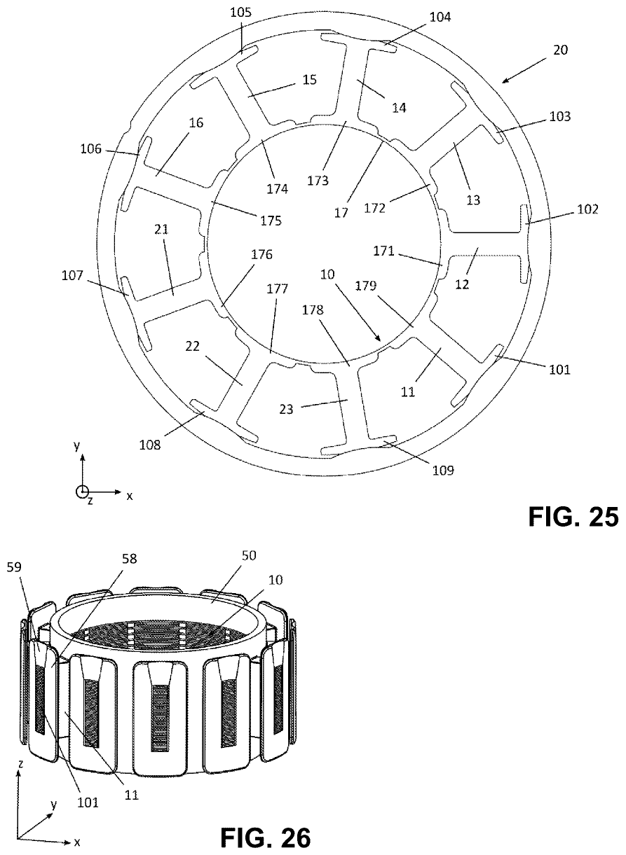

FIG. 25 illustrates a tenth variant embodiment for which the wound teeth (11, 12, 13, 14, 15, 16, 21, 22, 23) radially extend the annular yoke (17) of the first stator part (10) and have flared tooth ends (101, 102, 103, 104, 105, 106, 107, 108, 109) and flared tooth bases (171, 172, 173, 174, 175, 176, 177, 178, 179). This embodiment is particularly advantageous for directly on the teeth with rigid wires that are, for example, greater than 1 mm in diameter for copper. The flares, made directly in the stack of laminations, offer a sufficiently rigid radial stop of the wire, which does not deform during the winding operation, and facilitates the assembly of the two stator parts (10, 20). It can also be noted that the widening of the tooth bases (171, 172, 173, 174, 175, 176, 177, 178, 179) promotes the collection of the magnetic flux generated by the rotor; of course, the annular yoke (17) has a constriction, easily magnetically saturable, between each flare so as to minimize magnetic leakage. This embodiment also allows an orientation of the patterns for cutting the laminations that is different from the assembly orientation in order to be able to cut the laminations of the first stator part and the second stator part (10, 20) in the same stack.

### Description of a Tenth Embodiment

FIG. 26 illustrates an eleventh embodiment for which the first stator part (10) is molded over a plastic body (50). This plastic body (50) forms a coil body (58) on each tooth (11), only one being pointed out in FIG. 26, making it easier to wind. Each of the coil bodies (58) also has, at the radial end, a flared groove (59) extending from the upper face of the stack of laminations constituting the first stator part (10) to the axial end of the plastic body and widening adiabatically in the tangential direction. These flared grooves (59) advantageously make it possible to align the tooth ends (101) with their receiving region (not shown) of the first and second stator parts (10, 20). A plastic constituting the sufficiently rigid plastic body can be chosen in order to be able to support and generate sufficient elastic deformation of one or the other of the stacks of laminations constituting the first stator part and the second stator part (10, 20) during the axial insertion of one into the other. This would make it possible to guide the deformation of the stator parts to allow their insertion, which confers a substantial advantage on an assembly line. It may be noted that the adiabatic tangential widening is only an example corresponding to a need to align or deform the stator parts (10, 20) tangentially, but the person skilled in the art would know how to extrapolate this teaching to serve other needs. For example, the flared grooves (59) could flare in the radial direction to provide guidance and deformation support in this direction. The flare could also not be adiabatic but could have a significant slope at the start of the insertion, then a gentler slope in order to vary the force required during the insertion.

It can also be noted that this embodiment is not limited to a plastic overmolding of one or the other of the stator parts (10, 20); the flared grooves (59) could also be made in coil bodies assembled on the teeth.

1. A slotted, electric radial flux machine comprising a stator having a stator axis and comprising two stator parts connected by a plurality of teeth, some or all of which are surrounded by coils, the two stator parts having a first pattern and a second pattern, respectively, in a plane perpendicular to the stator axis, wherein:
each of the teeth surrounded by coils is an extension of one of the first or second patterns and has a front end engaging with a receiving region of the other of the first or second patterns to form a unique point of contact that is constrained within the plane.

2. A slotted, electric radial flux machine comprising a stator having a stator axis and comprising two stator parts connected by a plurality of teeth, some or all of which are surrounded by coils, the two stator parts having a first pattern and a second pattern, respectively, in a plane perpendicular to the stator axis, each of the teeth surrounded by coils being an extension of one of the first or second patterns and having a front end engaging with a receiving region of the other of the first or second patterns, wherein:
the first and second patterns have at least one overlapping area at a point of engagement between the front end and the receiving region, the overlapping area being able to be absorbed by an elastic deformation, greater than manufacturing tolerances, of at least one or the other of the two stator parts linked to movement of the front end.

3. The machine of claim 1, wherein lines normal to contact surfaces between the teeth and corresponding receiving regions pass through the unique points of contacts, are not concurrent at a single point coinciding with the stator axis.

4. The machine of claim 1, wherein the stator has at least three teeth surrounded by coils, each of the at least three teeth producing a constrained point of contact.

5. The machine of claim 1, wherein an extent of a region of the constrained point of contact is less than 5% of a periphery of the front end of the tooth.

6. The machine of claim 1, wherein all of the teeth consist of extensions of only one of the two stator parts.

7. The machine of claim 1, wherein the teeth consist partly of extensions of one of the two stator parts and partly of extensions of the other of the two stator parts.

8. The machine of claim 1, wherein the front end of at least one of the teeth is convex, and wherein the corresponding receiving region is concave, with a greater radius of curvature.

9. The machine of claim 1, wherein the front end of at least one of the teeth is concave, and wherein the corresponding receiving region is convex, with a smaller radius of curvature.

10. The machine of claim 1, wherein the front end of at least one of the teeth is convex, and wherein the corresponding receiving region is flat.

11. The machine of claim 1, wherein the front end of at least one of the teeth and its corresponding receiving region are convex.

12. The machine of claim 1, wherein the two stator parts consist of stacked laminations, one of the first or second patterns fitting into the other of the first or second patterns.

13. The motor of claim 1, further comprising a rotor external to the stator.

14. The motor of claim 1, further comprising a rotor internal to the stator.

15. The motor of claim 1, wherein the stator alternates between wide teeth and narrow teeth, only three teeth configured for receiving coils and being located in an angular sector α of angular extent less than 180°.

16. The machine of claim 1, wherein a first stator part is overmolded with a plastic body forming a coil body on each of the teeth surrounded by coils, the coil body axially extending the front end of the teeth by a flared groove.

17. The machine of claim 16, wherein the flared grooves of the plastic body have sufficient rigidity to withstand the elastic deformation stresses of the first or second stator part exerted during assembly by axial insertion of the first and second stator parts.

18. The machine of claim 2, wherein the stator has at least three teeth surrounded by coils, each of the at least three teeth producing a constrained point of contact.

19. The machine of claim 2, wherein an extent of a region of the constrained point of contact is less than 5% of a periphery of the front end of the tooth.

20. The machine of claim 2, wherein all of the teeth consist of extensions of only one of the two stator parts.
